(19) United States
(12) Patent Application Publication
(10) Pub. No.: US 2018/0032704 A1
(43) Pub. Date: Feb. 1, 2018

(54) REACTION MECHANISM GENERATION METHOD AND REACTION MECHANISM GENERATION DEVICE

(71) Applicant: KABUSHIKI KAISHA TOYOTA CHUO KENKYUSHO, Nagakute-shi, Aichi-ken (JP)

(72) Inventor: Hirotoshi HIRAI, Nagakute-shi (JP)

(73) Assignee: Kabushiki Kaisha Toyota Chuo Kenkyusho, Nagakute-shi, Aichi-ken (JP)

(21) Appl. No.: 15/551,071

(22) PCT Filed: Feb. 10, 2016
(86) PCT No.: PCT/JP2016/054026

§ 371 Date: Aug. 15, 2017

(30) Foreign Application Priority Data
Feb. 19, 2015 (JP) 2015-030932

(51) Int. Cl. G06F 19/00; B01J 19/00

(52) U.S. Cl. CPC G06F 19/701; B01J 19/0033

(57) ABSTRACT

A reaction mechanism generation method comprises the steps of: carrying out the molecular dynamics calculation on atoms constituting each molecule in a reaction system in every time step; when a chemical reaction occurs in the reaction system before and after the time step, identifying a reaction molecule that contributes to the chemical reaction and a generated molecule; constituting an elementary reaction constituted by the reaction molecule and the generated molecule which are related to each other on the basis of the atom-level relation between the reaction molecule and the generated molecule; and calculating a reaction rate constant of the above-constituted elementary reaction.

### TECHNICAL FIELD

The present invention relates to technology for a reaction mechanism generation method and a reaction mechanism generation device.

### BACKGROUND

In production processes, process simulations are increasingly being investigated to improve productivity and the like.

For example, in a production process using a chemical reaction, investigations are made to ascertain how the reaction occurs, and how the yield and the reaction rate and the like can be improved. In order to conduct this type of process simulation, details of the reaction mechanism and calculation of the reaction rate and the like are required.

For example, Patent Document 1 and Non-Patent Document 1 propose methods for predicting a reaction mechanism by using molecular dynamics calculations to calculate information on interatomic bonding, and then predicting the reaction mechanism based on changes in that interatomic bonding information.

### CITATION LIST

### Patent Literature

Patent Document 1: JP 4713856 B

### Non Patent Literature

Non-Patent Document 1: Journal of Molecular Graphics and Modeling, 53 (2014), 13 to 22.

### SUMMARY

### Technical Problem

However, in the case of a reaction of a complex system containing many molecules, for example when a plurality of elementary reactions such as A+B→D+E and C→F+G are occurring simultaneously, the methods of Patent Document 1 and Non-Patent Document 1 give no consideration to analysis of these types of elementary reactions. Accordingly, with the methods of Patent Document 1 and Non-Patent Document 1, when the reaction of a complex system containing many molecules is analyzed, an apparent polymolecular reaction such as A+B+C→D+E+F is extracted, meaning the reaction can sometimes not be analyzed accurately.

Accordingly, an object of the present invention is to provide a reaction mechanism generation method and a reaction mechanism generation device that enable a reaction to be analyzed accurately, even when analyzing the reaction of a complex system containing many molecules.

### Solution to Problem

The reaction mechanism generation method of the present invention includes a step of performing a molecular dynamics calculation at each time step for the atoms that constitute each molecule in a reaction system, a step, performed when a chemical reaction has occurred in the reaction system before and after the time step, of identifying a reacting molecule and a product molecule that contributed to the chemical reaction, a step of constructing, based on the atomic relationships between the reacting molecule and the product molecule, an elementary reaction structured from the reacting molecule and the product molecule having the aforementioned relationship, and a step of calculating a reaction rate constant for the constructed elementary reaction.

Further, in the above reaction mechanism generation method, in the step of identifying a reacting molecule and a product molecule, the reacting molecule and the product molecule that contributed to the chemical reaction are preferably identified from positional information for the atoms obtained from molecular dynamics calculations performed before and after the time step.

Furthermore, in the above reaction mechanism generation method, in the step of calculating a reaction rate constant for the elementary reaction, it is preferable that the time history of the number of molecules of the same molecular species as the reacting molecule is calculated, and the reaction rate constant for the elementary reaction is then calculated based on this time history of the number of molecules of the same molecular species as the reacting molecule.

Further, the above reaction mechanism generation method preferably includes a step of creating a base model containing a plurality of elementary reactions constructed in the step of constructing an elementary reaction, and a step of creating a simplified model having fewer elementary reactions than the base model, by narrowing down the plurality of elementary reactions of the base model based on the number of times each elementary reaction occurred during the molecular dynamics calculation.

Further, the above reaction mechanism generation method preferably includes a step of evaluating the accuracy of the above simplified model.

Furthermore, the above reaction mechanism generation method preferably includes a step of creating a base model containing a plurality of elementary reactions constructed in the step of constructing an elementary reaction, and a step of creating a simplified model having fewer elementary reactions than the base model, by narrowing down the plurality of elementary reactions of the base model based on the number of times each elementary reaction occurred during the molecular dynamics calculation and the number of temperature settings, among the plurality of temperature settings set in the molecular dynamics calculation, at which the same elementary reaction exists.

Further, the above reaction mechanism generation method preferably includes a step of evaluating the accuracy of the above simplified model.

Moreover, a reaction mechanism generation device of the present invention includes a molecular dynamics calculation unit that performs a molecular dynamics calculation at each time step for the atoms that constitute each molecule in a reaction system, a molecule identification unit which, when a chemical reaction has occurred in the reaction system before and after the time step, identifies a reacting molecule and a product molecule that contributed to the chemical reaction, an elementary reaction construction unit which, based on the atomic relationships between the reacting molecule and the product molecule, constructs an elementary reaction structured from the reacting molecule and the product molecule having the aforementioned relationship, and a reaction rate calculation unit that calculates a reaction rate constant for the constructed elementary reaction.

Further, in the above reaction mechanism generation device, the molecule identification unit preferably identifies the reacting molecule and the product molecule that contributed to the chemical reaction from positional information for the atoms obtained from molecular dynamics calculations performed before and after the time step.

Furthermore, in the above reaction mechanism generation device, the reaction rate calculation unit preferably calculates the time history of the number of molecules of the same molecular species as the reacting molecule, and calculates the reaction rate constant for the elementary reaction based on this time history of the number of molecules of the same molecular species as the reacting molecule.

Further, the above reaction mechanism generation device preferably includes a base model creation unit that creates a base model containing a plurality of elementary reactions constructed in the elementary reaction construction unit, and a simplified model creation unit that creates a simplified model having fewer elementary reactions than the base model, by narrowing down the plurality of elementary reactions of the base model based on the number of times each elementary reaction occurred during the molecular dynamics calculation.

Further, the above reaction mechanism generation device preferably includes a model accuracy evaluation unit that evaluates the accuracy of the above simplified model.

Furthermore, the above reaction mechanism generation device preferably includes a base model creation unit that creates a base model containing a plurality of elementary reactions constructed in the elementary reaction construction unit, and a simplified model creation unit that creates a simplified model having fewer elementary reactions than the base model, by narrowing down the plurality of elementary reactions of the base model based on the number of times each elementary reaction occurred during the molecular dynamics calculation and the number of temperature settings, among the plurality of temperature settings set in the molecular dynamics calculation, at which the same elementary reaction exists.

Further, the above reaction mechanism generation device preferably includes a model accuracy evaluation unit that evaluates the accuracy of the above simplified model.

### Advantageous Effects of Invention

The present invention can analyze a reaction with good accuracy, even when analyzing the reaction of a complex system containing many molecules.

### BRIEF DESCRIPTION OF DRAWINGS

FIG. 1 is a block diagram illustrating an example of the structure of a reaction mechanism generation device according to an embodiment of the present invention.

FIG. 2 is a flowchart illustrating an example of the reaction mechanism generation method of an embodiment of the present invention.

FIG. 3 is a diagram in which the presence or absence of a bond between each of a series of atoms is represented as matrix information.

FIG. 4 is a diagram illustrating the matrix information indicating the presence or absence of a bond between each of a series of atoms converted to block diagonal matrix information.

FIG. 5 is a diagram describing the atomic relationships of identified reacting molecules and product molecules.

FIG. 6 is a diagram in which the presence or absence of atomic relationships between reacting molecules and product molecules is represented as matrix information.

FIG. 7 is a diagram illustrating the changes in the numbers of molecular species A and B over the time a specific elementary reaction occurred.

FIG. 8 is a diagram illustrating the relationship between the reaction rate and the temperature, and also illustrating the Arrhenius equation.

FIG. 9 is a block diagram illustrating an example of the structure of a reaction mechanism generation device according to an embodiment of the present invention.

FIG. 10 is a flowchart illustrating an example of the operation of a reaction mechanism generation device of an embodiment of the present invention.

FIG. 11 is a diagram illustrating a state where hydrogen molecules and oxygen molecules are arranged in a simulation cell.

FIG. 12 is a diagram illustrating the changes over time in the numbers of specific molecules in Example 1.

FIG. 13 is a diagram illustrating a list of elementary reactions constructed in Example 1.

FIG. 14 is a diagram illustrating the results of calculating the reaction rate constant for the elementary reaction H₂+O→OH+H.

FIG. 15 is a diagram illustrating a portion of a base model including elementary reactions at 3000 K, the reaction rate constants, and the number of times elementary reactions occurred during the molecular dynamics calculation.

FIG. 16 is a diagram illustrating a portion of a simplified model including elementary reactions, parameters (A, n, Ea), and the number of temperature settings at which each elementary reaction occurred.

FIG. 17 is a diagram illustrating the changes over time in mole fractions at 3000 K using a 3_4 simplified model, and the changes over time in the mole fractions obtained by molecular dynamics calculations.

FIG. 18 is a diagram illustrating the number of elementary reactions and the number of chemical species in each of a series of simplified models.

FIG. 19 is a diagram illustrating the results of calculating the ignition delay time for the 3_2 simplified model through to the 20_5 simplified model.

FIG. 20 is a diagram illustrating the changes over time in mole fractions at 3000 K using a 10_5 simplified model.

FIG. 21 is a diagram showing the results for the number of elementary reactions and the number of chemical species in simplified models obtained using three conventionally known simplification methods.

### DESCRIPTION OF EMBODIMENTS

Examples of embodiments of the present invention are described below based on the drawings.

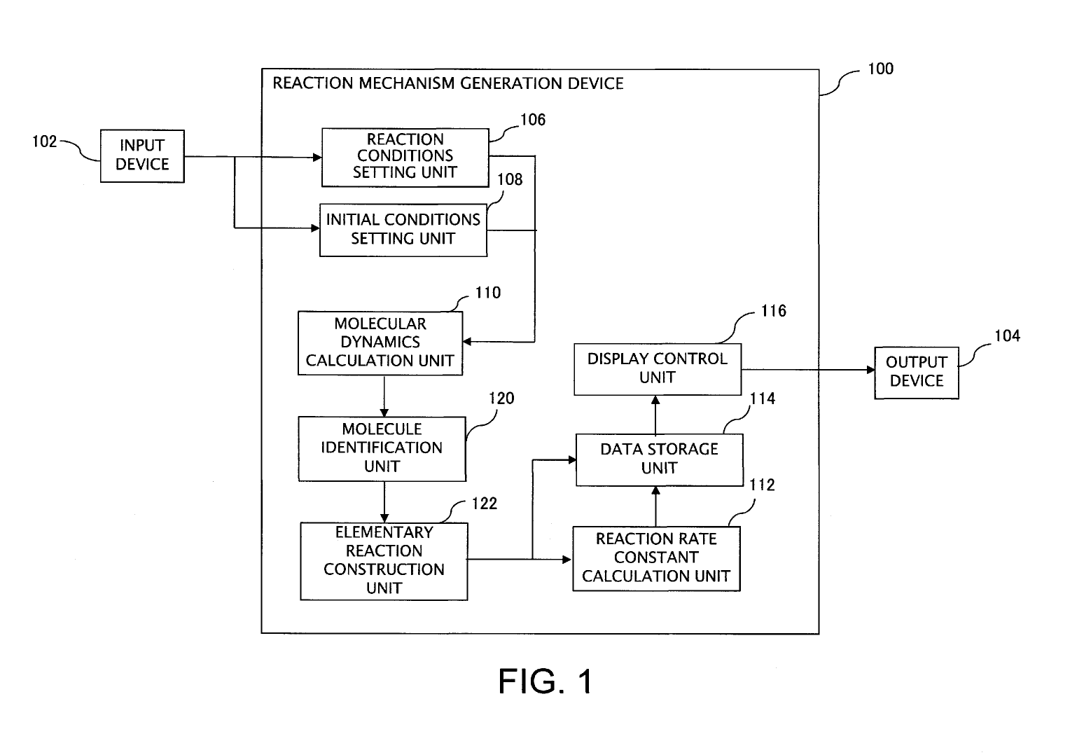

FIG. 1 is a block diagram illustrating one example of the structure of a reaction mechanism generation device according to an embodiment of the present invention. Each of the illustrated blocks can be realized using elements including a computer CPU (central processing unit) and mechanical devices from a hardware perspective, and using a computer program or the like from a software perspective, but this drawing is drawn with functional blocks realized through a combination of these items. Accordingly, it should be understood by a person skilled in the art reading this description that these functional blocks can be realized in a variety of forms through various combinations of hardware and software.

As illustrated in FIG. 1, the reaction mechanism generation device 100 is connected to an input device 102 and an output device 104. The input device 102 may be a keyboard and/or mouse or the like for receiving user input relating to the processing to be executed by the reaction mechanism generation device 100. The input device 102 may be constructed so as to receive input from a network such as the internet, or from a recording medium such as a CD or DVD. The output device 104 may be a display device such as a display or a printing device such as a printer.

The reaction mechanism generation device 100 contains a reaction conditions setting unit 106, an initial conditions setting unit 108, a molecular dynamics calculation unit 110, a molecule identification unit 120, an elementary reaction construction unit 122, a reaction rate constant calculation unit 112, a data storage unit 114, and a display control unit 116.

The reaction conditions setting unit 106 sets reaction conditions such as the initial molecular species within the reaction system, the number of each of the initial molecular species, and the temperature, pressure and volume and the like of the reaction system, based on input information that has been input by a user via the input device 102.

The initial conditions setting unit 108 sets the initial conditions required for the molecular dynamics calculation such as the positional information for the atoms that constitute the molecules and the speed of the atoms, based on input information that has been input by a user via the input device 102. When the number of molecules is set to a plurality of molecules, the initial conditions setting unit 108 sets the positional information and speed of each atom randomly within a range that does not destroy the structure of the molecule.

The molecular dynamics calculation unit 110 performs a molecular dynamics calculation involving sequential calculations conducted by time integration of Newton's equation of motion, under the preset reaction conditions and initial conditions, thereby calculating the positional information and speed and the like of each atom at each time step.

When a chemical reaction has occurred in the reaction system before and after the time step between molecular dynamics calculations, the molecule identification unit 120 identifies the reacting molecules and the product molecules that contributed to the chemical reaction from the positional information for the atoms obtained from the molecular dynamics calculations performed before and after the time step. As described below, the determination as to whether or not a chemical reaction has occurred in the reaction system is made on the basis of changes in the bond distances between atoms, the bond order, and the number of molecules.

Based on the atomic relationships between the identified reacting molecules and product molecules, the elementary reaction construction unit 122 constructs an elementary reaction structured from the reacting molecules and the product molecules having the atomic relationships. As described below, the atomic relationships between the reacting molecules and the product molecules are determined by comparing the atoms that constitute the reacting molecules and the atoms that constitute the product molecules to ascertain whether or not the atoms that constitute the reacting molecules are contained within the product molecules.

The reaction rate constant calculation unit 112 calculates the reaction rate constant for the identified elementary reaction using a reaction rate formula.

The data storage unit 114 stores the elementary reaction constructed by the elementary reaction construction unit 122 and the reaction rate constant calculated by the reaction rate constant calculation unit 112 as data. The display control unit 116 displays the elementary reaction and the reaction rate constant stored in the data storage unit 114 on the output device 104.

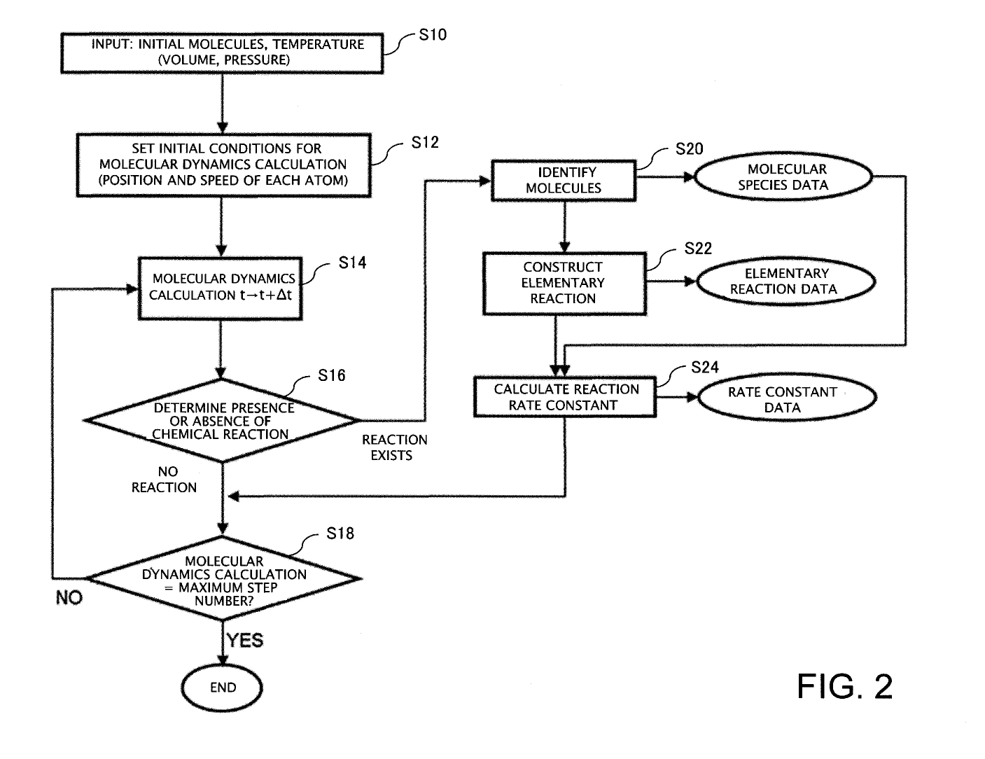

The operation of the reaction mechanism generation device 100 according to the present embodiment is described below in accordance with the flowchart shown in FIG. 2.

In step S10, various conditions relating to the reaction system that is to be analyzed are set by the reaction conditions setting unit 106. These various conditions for the reaction system include the initial molecular species, the number of each of the initial molecular species, and the temperature, pressure and volume and the like of the reaction system. The initial molecular species refer to the reacting molecules and the like that act as the raw materials in the reaction system, and examples include molecules composed of a plurality of atoms, single-atom molecules, ions, and radicals and the like. There are no particular limitations on the number of each of the initial molecular species, but in terms of facilitating the emergence of various reaction pathways, setting a multiple number is preferable.

In step S12, the initial conditions used in the molecular dynamics calculation are set by the initial conditions setting unit 108. The initial conditions refer to the position and speed and the like of the atoms that constitute the molecules in the reaction system. When the number of molecules is set to a multiple number as mentioned above, the position and speed of each atom are set randomly within ranges that do not destroy the structure of the molecule. Further, when the molecular dynamics calculation is performed for a plurality of molecules, each molecule is arranged with appropriate spacing between molecules, and is oriented in a random direction.

In step S14, a molecular dynamics calculation is performed at each time step by the molecular dynamics calculation unit 110 for the atoms that constitute the molecules in the reaction system. A molecular dynamics calculation is a technique in which calculation is performed in accordance with Newton's equation of motion represented by formula (1) shown below, under the various conditions of the reaction system and the initial conditions used for the molecular dynamics calculation. The molecular dynamics calculation unit 110 specifies a time step (Δt), and then sequentially calculates the positional information of atoms following Δt by time integration of Newton's equation of motion.

$$\begin{matrix}[ Formula 1 ] & \\ {m}_{i} \frac{{d}^{2} {R}_{i}}{{dt}^{2}} = {F}_{i} & ( 1 )\end{matrix}$$

mᵢ: mass of i^{th} atom

Rᵢ: position (Xᵢ,Yᵢ,Zᵢ) of i^{th} atom

Fᵢ: force (FₓᵢF_{yi},F_{zi}) acting upon i^{th} atom

The force (F) acting upon an atom can be determined, for example, by non-empirical methods such as first principle calculations, or by empirical methods such as molecular force field methods. The accuracy of the calculation of the force acting upon the atom has a significant effect on the calculation results for the position and speed of the atom determined by the molecular dynamics calculation, and therefore a method that can accurately describe the chemical reactions that can occur in the reaction system is preferable.

By performing these types of molecular dynamics calculations, the position (R) of each atom can be determined at each preset time step. Hereafter, the position of each atom is termed the positional information. Further, because the distance of movement of each atom during the time step can be ascertained from the positional information of the atom at each time step, the speed of the atom can be determined from this distance of movement. Alternatively, the speed of the atom may be determined by calculating a time difference equation relating to speed.

In step S16, a determination is made by the molecule identification unit 120 as to whether or not a chemical reaction has occurred in the reaction system before and after the time step(t→t+Δt) of the molecular dynamics calculation. The determination as to whether or not a chemical reaction has occurred can be made, for example, using the methods described below. Specifically, the methods include (A) a method in which the presence or absence of bonds between each of the atoms is evaluated based on the size of the bond distance or bond order between each of the atoms, and a chemical reaction is deemed to have occurred when the presence or absence of bonds between the atoms differs before and after the time step of the molecular dynamics calculation, and (B) a method in which the molecular species of each molecule is identified based on the positional information of each of the atoms, and a chemical reaction is deemed to have occurred when the number of molecules of any molecular species differs before and after the time step of the molecular dynamics calculation. A more detailed description of the methods (A) and (B) is presented below.

### <Method (A)>

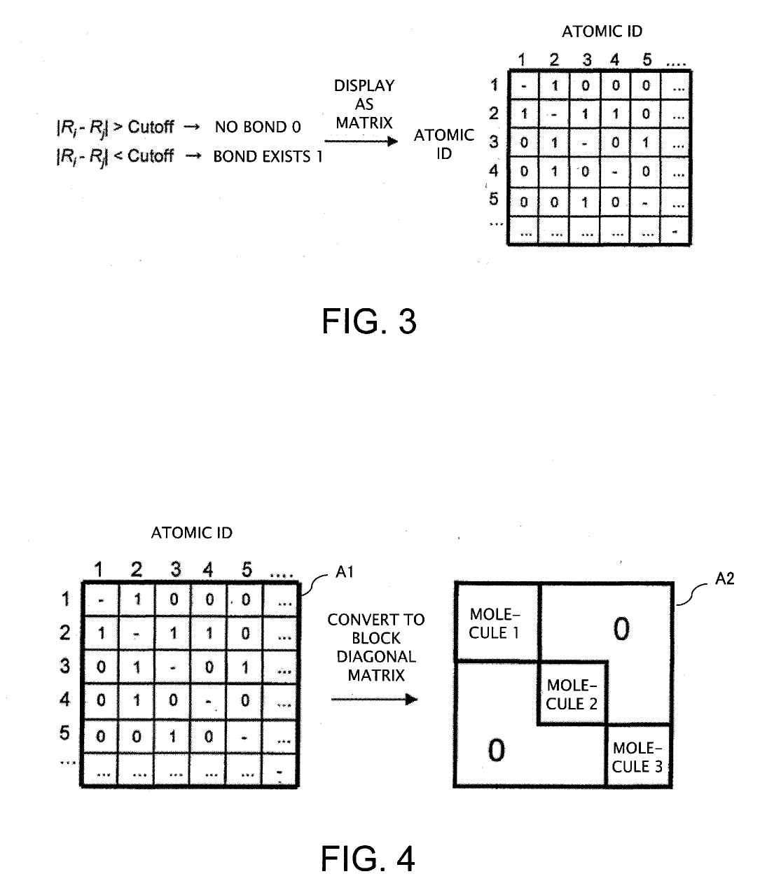

FIG. 3 is a diagram in which the presence or absence of a bond between each of a series of atoms is represented as matrix information. For example, in a reaction system in which an atomic ID (1, 2, 3, 4, 5 . . . ) is assigned to each atom that constitutes a molecule in the reaction system, the differences between the positional information (R) of each atom at a time t are determined. The absolute value of the difference between the positional information of two atoms indicates the bond distance between those two atoms. Then, as illustrated in the left side of FIG. 3, in those cases where the bond distance between any two atoms exceeds a cutoff, the atoms are evaluated as having no bond, whereas if the bond distance between the atoms is less than the cutoff, a bond is deemed to exist. Then, a “1” is assigned when a bond is deemed to exist between atoms, a “0” is assigned in the case of no bond, and the results are summarized as matrix information such as that shown in the right side of FIG. 3. Further, based on the positional information of each of the atoms after the time step Δt (namely, time t+Δt), the same procedure is used to evaluate the presence or absence of bonds, and the results are again summarized as matrix information. Subsequently, the matrix information at time t and the matrix information after the time step Δt (time t+Δt) are compared, and when the presence or absence of bonds between the atoms changes, a chemical reaction is deemed to have occurred.

Further, in the first principle calculation technique and in some molecular force field methods, the bond order between each of the atoms can be determined, and when the bond order between atoms is used, a bond is deemed to exist and a value of “1” is assigned when the bond order between two atoms exceeds a cutoff, a bond is deemed not to exist and a value of “0” is assigned when the bond order is less than the cutoff, and matrix information is created. Then, in a similar manner to that described above, the matrix information at time t and the matrix information after the time step Δt are compared, and when the presence or absence of bonds between the atoms changes, a chemical reaction is deemed to have occurred.

### <Method (B)>

As described below, the molecular species of each molecule in the reaction system can be identified from the positional information of the atoms, and this enables the number of molecules of each molecular species to be determined at each time step. These numbers are compared before and after a time step, and when a molecular species exists for which the number of molecules has changed, a chemical reaction is deemed to have occurred.

When a chemical reaction is deemed to have not occurred during a time step of the molecular dynamics calculation, the process proceeds to step S18, whereas when a chemical reaction is deemed to have occurred, the process proceeds to step S20. A determination of whether or not a chemical reaction has occurred may be made for each time step of the molecular dynamics calculation, but because the time step for the molecular dynamics calculation is generally shorter than the time required for a chemical reaction to occur, the determination may be made every plurality of time steps.

In step S18, a determination is made as to whether or not the time step number of the molecular dynamics calculation has reached its maximum value, and if the number is less than the maximum step number, the process returns to the molecular dynamics calculation of step S14, whereas if the time step number has reached the maximum step number, the process ends. Determination as to whether or not the molecular dynamics calculation has reached the maximum step number may be made by the molecule identification unit 120, but a separate step number determination unit may be provided, with determination then made by this step number determination unit. Further, the maximum step number may be determined appropriately based on the number of molecules in the reaction system and the like.

In step S20, the reacting molecules and the product molecules that contributed to the chemical reaction that occurred before and after the time step of the molecular dynamics calculation are identified by the molecule identification unit 120. In the method used for identifying the molecules, identification is performed based on information such as the positional information of the atoms obtained from the molecular dynamics calculation or the matrix information (bond information) that indicates the presence or absence of bonds between atoms. A more detailed description is presented below.

Molecules are identified from the positional information of atoms at a time t, and then in a similar manner, molecules are identified again after a time step Δt from the positional information of atoms. Then, those molecules that were identified at the time t but were not then included in the molecules identified after the time step Δt (for example, a molecule 1 composed of atoms of ID 1 and 2, a molecule 2 composed of atoms of ID 152 and 153, and a molecule 3 composed of atoms of ID 12, 140 and 141) are identified as the reacting molecules that contributed to the chemical reaction. Further, those molecules that were identified after the time step Δt but were not included among the molecules that were identified at the time t (for example, a molecule 4 composed of the atom of ID 2, a molecule 4 composed of atoms of ID 1, 152 and 153, a molecule 6 composed of the atom of ID 12, and a molecule 7 composed of atoms of ID 140 and 141) are identified as product molecules that contributed to the chemical reaction.

FIG. 4 is a diagram illustrating the matrix information indicating the presence or absence of a bond between each of a series of atoms converted to block diagonal matrix information. When the matrix information indicating the presence or absence of bonds between atoms is used to determine whether or not a chemical reaction has occurred, then for example, the atoms for which a bond exists are preferably rearranged from the matrix information A1 illustrated in FIG. 4 to create the block diagonal matrix information A2 which displays the atoms separated into individual molecules. This type of block diagonal matrix information is created from the matrix information at time t and the matrix information following the time step Δt, and those molecules from the block diagonal matrix information at time t that do not exist in the block diagonal matrix information following the time step Δt are identified as reacting molecules that contributed to the chemical reaction. Further, those molecules from the block diagonal matrix information following the time step Δt that did not exist in the block diagonal matrix information at time t are identified as product molecules that contributed to the chemical reaction.

By listing the reacting molecules identified in this manner on the left side, and listing the product molecules on the right side, a reaction equation can be constructed. However, in the case of a reaction of a complex system containing multiple molecules, for example even if reactions such as molecule 1+molecule 2→molecule 4+molecule 5, and molecule 3→molecule 6+molecule 7 are occurring simultaneously, if an attempt is made to construct a reaction equation from step S20, then a mixed reaction equation of the plurality of elementary reactions represented by molecule 1+molecule 2+molecule 3→molecule 4+molecule 5+molecule 6+molecule 7 is extracted, and therefore the accuracy of the reaction analysis can sometimes not be fully guaranteed. Accordingly, in order to enable accurate analysis of the reaction mechanism, the true elementary reactions must be constructed.

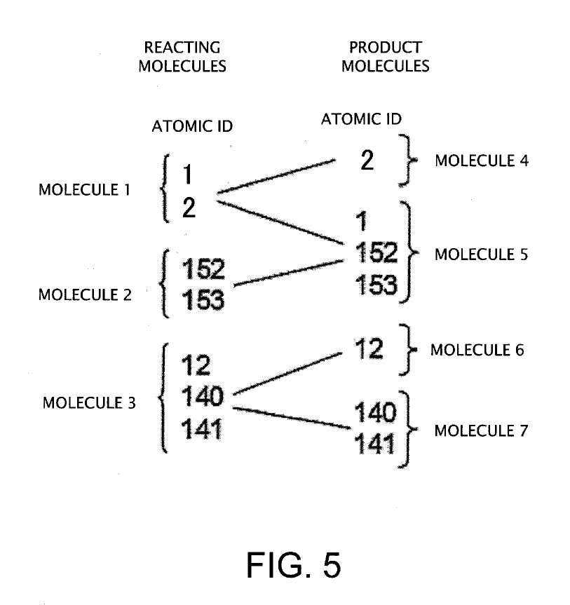

In step S22, an elementary reaction is constructed by the elementary reaction construction unit 122 based on the atomic relationships between the identified reacting molecules and product molecules. FIG. 5 is a diagram describing the atomic relationships of identified reacting molecules and product molecules. As illustrated in FIG. 5, in the case where molecules 1, 2 and 3 have been identified as reacting molecules, and molecules 4, 5 and 6 have been identified as product molecules, the atoms that constitute each of the reacting molecules and the atoms that constitute each of the product molecules are compared, and when an atom contained in a reacting molecule is included among the atoms of a product molecule, that reacting molecule and product molecule are deemed to have a relationship. For example, as illustrated in FIG. 5, the atoms of molecule 1 are included in the atoms of molecules 4 and 5, but not included in the atoms of molecules 6 and 7, and therefore molecule 1 can be deemed to have relationships with molecules 4 and 5 but lack relationships with molecules 6 and 7. Molecule 2 has a relationship with molecule 5 that also has a relationship with molecule 1. Based on these atomic relationships, an elementary reaction is constructed from molecules 1, 2, 4 and 5. Further, because molecule 3 has relationships with molecules 6 and 7, but lacks relationships with molecules 4 and 5, an elementary reaction can be constructed from molecules 3, 6 and 7. By listing the reacting molecules on the left side and the product molecules on the right side, two elementary reactions, namely molecule 1+molecule 2→molecule 4+molecule 5, and molecule 3→molecule 6+molecule 7, can be constructed. This extracted elementary reaction data is sent to the reaction rate constant calculation unit 112 and also stored in the data storage unit 114.

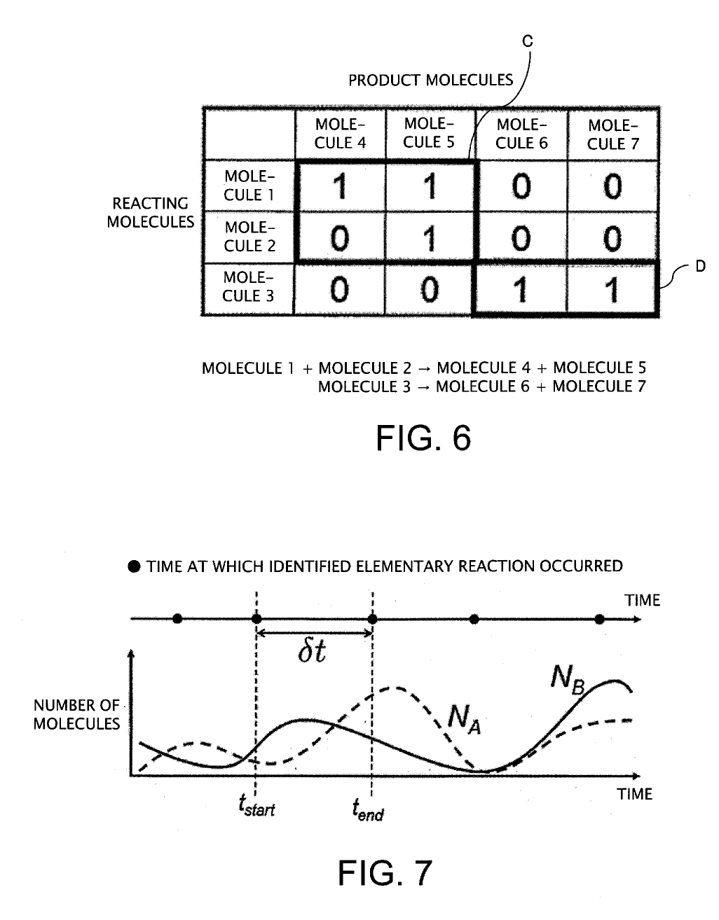

FIG. 6 is a diagram in which the presence or absence of atomic relationships between reacting molecules and product molecules is represented as matrix information. As illustrated in FIG. 6, for the atomic relationships between the reacting molecules and product molecules, a value of “1” is assigned when a relationship exists, a value of “0” is assigned when no relationship exists, and the molecules for which relationships exist can then be grouped to create block diagonal matrix information. Each of the blocks C and D in FIG. 6 corresponds with a true elementary reaction. For each of the blocks shown in FIG. 6, by listing the reacting molecules on the left side and the product molecules on the right side, the elementary reactions molecule 1+molecule 2→molecule 4+molecule 5 and molecule 3→molecule 6+molecule 7 can be constructed.

In step S24, the reaction rate constant of each constructed elementary reaction is calculated by the reaction rate constant calculation unit 112. The reaction rate formula for a given molecular species A is represented by the upper line of the formula (2) shown below, using the reaction rate constant (k) for each elementary reaction. Moreover, as shown in the lower line of formula (2), this formula is also represented as the sum of the contributions of each of the simultaneously proceeding elementary reactions.

$$\begin{matrix}[ Formula 2 ] & \\ \begin{matrix}\frac{d [ A ]}{dt} = - {k}_{1} [ A ] + {k}_{2} [ B ] [ C ] - {k}_{3} [ A ] [ D ] … \\ = {( \frac{d [ A ]}{dt} )}_{1} + {( \frac{d [ A ]}{dt} )}_{2} + {( \frac{d [ A ]}{dt} )}_{3} …\end{matrix} & ( 2 )\end{matrix}$$

Further, for the contribution of each elementary reaction, if the reaction rate formula is represented as a difference formula, then the primary reaction of formula (3) shown below is represented by formula (4) shown below, and the secondary reaction of formula (5) shown below is represented by formula (6) shown below.

$$\begin{matrix}[ Formula 3 ] & \\ \frac{d [ A ]}{dt} = - k [ A ] & ( 3 ) \\ [ Formula 4 ] & \\ \frac{{N}_{A} ( t + δ t ) / V - {N}_{A} ( t ) / V}{δ t} = - {kN}_{A} ( t ) / V \\ \begin{matrix}k = - \frac{{N}_{A} ( t + δ t ) - {N}_{A} ( t )}{{N}_{A} ( t )} \frac{1}{δ t} \\ = \frac{1}{{N}_{A} δ t}\end{matrix} & ( 4 ) \\ [ Formula 5 ] & \\ \frac{d [ A ]}{dt} = - k [ A ] [ B ] & ( 5 ) \\ [ Formula 6 ] & \\ \frac{{N}_{A} ( t + δ t ) / V - {N}_{A} ( t ) / V}{δ t} = - {kN}_{A} ( t ) / V \cdot {N}_{B} ( t ) / V \\ \begin{matrix}k = - \frac{{N}_{A} ( t + δ t ) - {N}_{A} ( t )}{{N}_{A} ( t ) {N}_{B} ( t )} \frac{V}{δ t} \\ = \frac{V}{{N}_{A} {N}_{B} δ t}\end{matrix} & ( 6 )\end{matrix}$$

In the above formulas, N represents the number of molecules of each molecular species in the reaction system, V represents the volume of the reaction system, and δt represents the time required for an identified elementary reaction to occur once. Considering the contribution when the identified elementary reaction occurs once, in the case where the molecular species A is a reacting molecule, the value of N_{A}(t+δt)−N_{A}(t) from formula (4) becomes −1, resulting in the bottom line of formula (4). Further, in the case of a secondary reaction, when molecular species A and B of the reacting molecule are the same molecule, the value of N_{A}(t+δt)−N_{A}(t) becomes −2, but in such a case, because a factor of ½ appears on the left side of the reaction equation by definition, this −2 is canceled out, resulting in the bottom line of formula (6). In other words, when there is no contribution from other elementary reactions, the reaction rate constant k can be calculated directly from formula (2).

However, when a contribution from another elementary reaction exists, changes in the number of each molecule can occur during the period 6t due to the other elementary reaction, and therefore rather than determining the reaction rate constant from the formula (2), determining the reaction rate constant from formulas (7) and (8) shown below yields a more accurate calculation result.

$$\begin{matrix}[ Formula 7 ] & \\ Primary Reaction \\ {N}_{A} δ t = {\int }_{{t}_{start}}^{{t}_{end}} {N}_{A} ( t ) dt k = \frac{1}{{N}_{A} δ t} & ( 7 ) \\ [ Formula 8 ] & \\ Secondary Reaction \\ {N}_{A} {N}_{B} δ t = {\int }_{{t}_{start}}^{{t}_{end}} {N}_{A} ( t ) {N}_{B} ( t ) dt k = \frac{V}{{N}_{A} {N}_{B} δ t} & ( 8 )\end{matrix}$$

FIG. 7 is a diagram illustrating the changes in the numbers of molecular species A and B over the time an identified elementary reaction occurred. Formula 7 and formula 8 convert the denominators of formula 4 and formula 6 (N_{A}δt, N_{A}N_{B}δt) into time-integrated values of the number of each reacting molecule during the time period δt (from tₛₜₐᵣₜ to t_{end}) shown in FIG. 7, namely a time history of the number of each reacting molecule. Each elementary reaction can generally occur a plurality of times during the molecular dynamics calculation, and therefore by calculating the reaction rate constant every time the elementary reaction occurs and taking the statistical average of the plurality of obtained values, the accuracy of the calculation of the reaction rate constant can be further improved. Further, each time the elementary reaction occurs, the time-integrated value of the number of reacting molecules may be calculated within the time period δt and the reaction rate constant then calculated, but the average value for the reaction rate constant per occurrence of the elementary reaction may also be determined by determining the time-integrated value of the number of reacting molecules across the entire time period and then dividing by the number of times the elementary reaction occurred. The calculated reaction rate constant data is stored in the data storage unit 114.

Following calculation of the reaction rate constant, the process returns to step S18, a determination is made as to whether or not the time step number of the molecular dynamics calculation has reached its maximum value, and if the number is less than the maximum step number, the process returns to the molecular dynamics calculation of step S14, whereas if the time step number has reached the maximum step number, the process ends.

The present embodiment describes an example in which elementary reactions are extracted sequentially during the molecular dynamics calculation, but the invention is not limited to this particular configuration, and the molecular dynamics calculation may be executed through to the maximum step number, the positional information for each of the atoms stored, and this positional information for each of the atoms subsequently used to extract elementary reactions as a post-process.

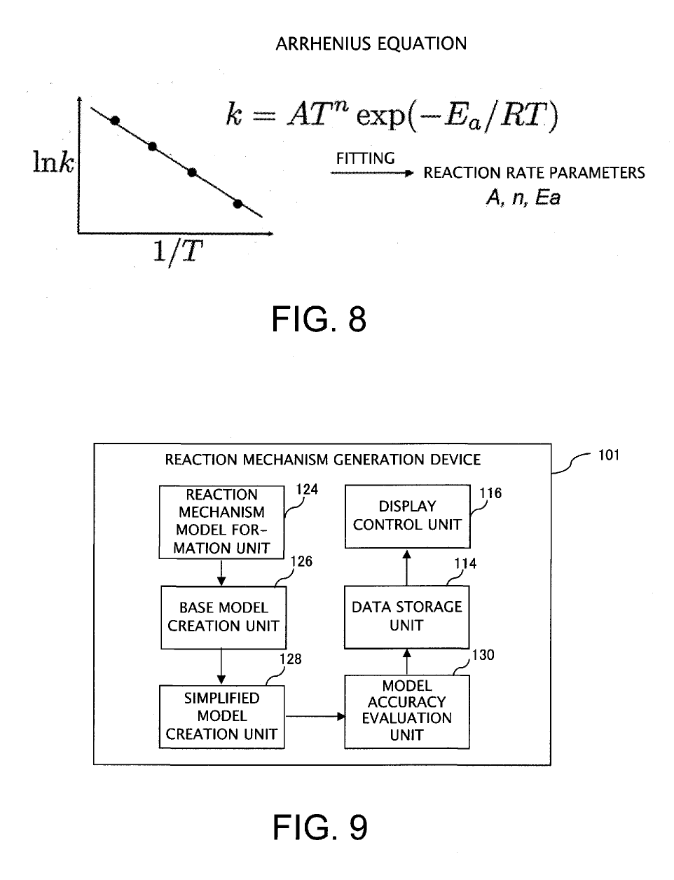

The reaction rate constant is generally dependent on the temperature, and therefore by performing a molecular dynamics calculation at a constant temperature using a hot bath, the reaction rate constant at a specified temperature can be determined. FIG. 8 is a diagram illustrating the relationship between the reaction rate and the temperature, and also illustrating the Arrhenius equation. As illustrated in FIG. 8, by determining the reaction rate constant at a plurality of temperatures, and then fitting the determined reaction rate constant values to the Arrhenius equation, the reaction rate parameters can be calculated.

As described above, in the present embodiment, even when the reaction system contains a plurality of reacting molecules, because the method includes the step of constructing elementary reactions from the atomic relationships between the reacting molecules and the product molecules, the risk of extracting an apparent multi-body reaction is reduced, and the true elementary reactions can be constructed, thus enabling the reaction system to be analyzed with good accuracy.

Other calculation methods such as transition state theory may also be used as the method for calculating the reaction rate constant. However, in terms of not requiring arithmetic processing with large associated calculation costs such as transition state searching, and enabling the reaction rate constant to be calculated easily, the method described above using the time history of the number of reacting molecules to calculate the reaction rate constant directly from the result of the molecular dynamics calculation is preferable.

The elementary reactions and reaction rate constants obtained in this manner can be used in a simulation of the reaction process. Further, by combining the results with fluid dynamics calculations, the effects of flow and diffusion can also be incorporated. Further, because a reaction mechanism (a combination of a series of elementary reactions and reaction rate constants) can be constructed without using experimental data or experimental rules, reaction mechanism simulations can be performed even for unknown systems.

Furthermore, the elementary reactions and reaction rate constants obtained in this manner can also be used in three-dimensional numerical fluid dynamics simulations and the like for modeling chemical processes and physical processes.

However, if an attempt is made, for example, to use three-dimensional numerical fluid dynamics simulations to perform an engine combustion simulation, then modeling of the chemical reactions of the fuel becomes a bottleneck. For example, if an attempt is made to model a complex reaction such as the combustion of a hydrocarbon fuel, then because the system includes an enormous number of chemical species and elementary reactions, a problem arises in that when a three-dimensional numerical fluid dynamics simulation is executed with consideration of the chemical reactions, the number of equations that require solution increases in proportion with the number of elementary reactions included in the model. Accordingly, in order to shorten the calculation time for the three-dimensional numerical fluid dynamics simulation, simplification of the reaction mechanism model is desirable.

A method for simplifying the reaction mechanism model is described below.

FIG. 9 is a block diagram illustrating an example of the structure of a reaction mechanism generation device according to an embodiment of the present invention. The reaction mechanism generation device 101 illustrated in FIG. 9 has a reaction mechanism model formation unit 124, a base model creation unit 126, a simplified model creation unit 128, a model accuracy evaluation unit 130, the data storage unit 114, and the display control unit 116. Each of the illustrated blocks can be realized using elements including a computer CPU (central processing unit) and mechanical devices from a hardware perspective, and using a computer program or the like from a software perspective, but this drawing is drawn with functional blocks realized through a combination of these items. Accordingly, it should be understood by a person skilled in the art reading this description that these functional blocks can be realized in a variety of forms through various combinations of hardware and software.

Although not shown in the drawing, the reaction mechanism model formation unit 124 illustrated in FIG. 9 contains the reaction conditions setting unit 106, the initial conditions setting unit 108, the molecular dynamics calculation unit 110, the molecule identification unit 120, the elementary reaction construction unit 122 and the reaction rate constant calculation unit 112 illustrated in FIG. 1, and performs elementary reaction construction and reaction rate constant calculations at a plurality of temperature settings. The construction of the elementary reactions and the calculation of the reaction rate constants are performed in the same manner as described above, and therefore further description is omitted here.

The base model creation unit 126 illustrated in FIG. 9 creates a base model including each of the elementary reactions and the reaction rate constant of each elementary reaction at each temperature setting, and the number of times each elementary reaction occurred during the molecular dynamics calculation.

The simplified model creation unit 128 illustrated in FIG. 9 narrows down the elementary reactions that exist in the base model created by the base model creation unit 126, and creates a simplified model having fewer elementary reactions than the base model. Creation of the simplified model is described below in detail.

The model accuracy evaluation unit 130 illustrated in FIG. 9 evaluates the accuracy of the simplified model created by the simplified model creation unit 128. Evaluation of the model accuracy is performed by comparing the chemical properties of the simplified model and the chemical properties of the base model, and ascertaining whether the difference falls within a specified tolerance. If the difference falls within the tolerance, then the simplified model is transmitted to the data storage unit 114 as a simplified reaction mechanism model.

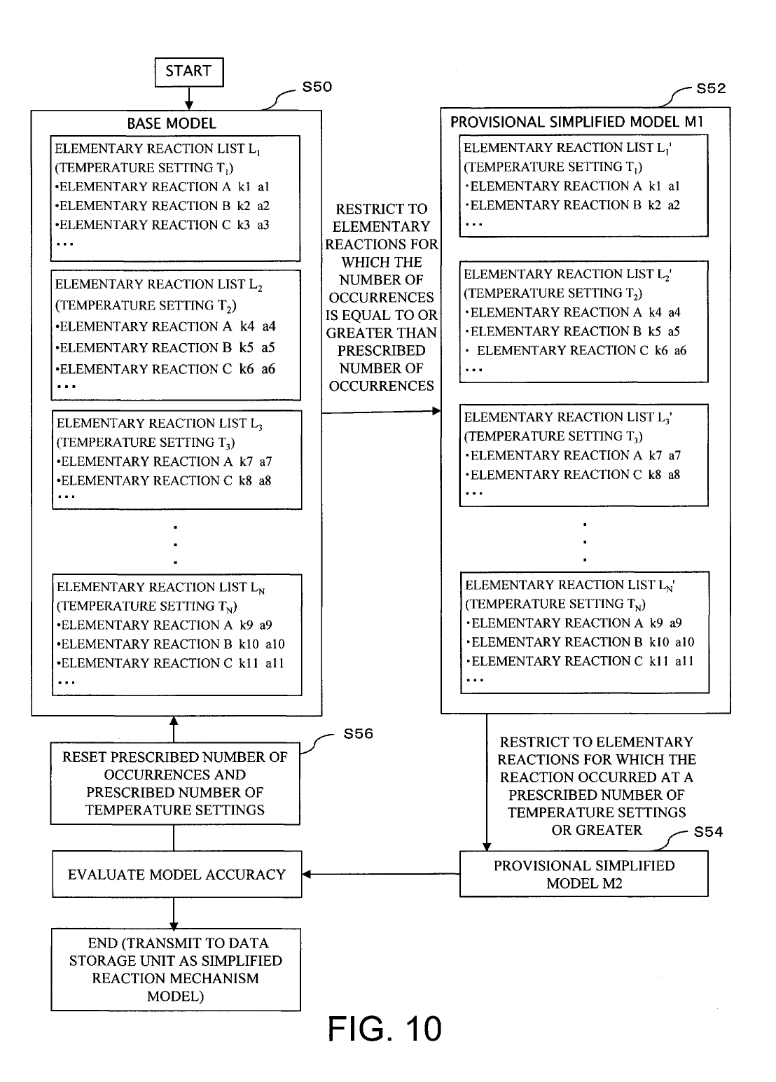

Next, one example of the operation of the reaction mechanism generation device 101 of the present embodiment is described below with reference to the flowchart of FIG. 10.

In step S50, the base model creation unit 126 creates a base model represented by an elementary reaction list L₁ to L_{N} including, for example, each elementary reaction (elementary reaction A, elementary reaction B, elementary reaction C . . . ), the reaction rate constant of each elementary reaction (k1, k2, k3 . . . ) and the number of times each elementary reaction occurred during the molecular dynamics calculation (a1, a2, a3 . . . ), for each of the temperature settings T₁ to T_{N} (for example, 3000 K, 3250 K . . . ).

The elementary reactions and the reaction rate constant for each elementary reaction refer to the elementary reactions constructed by the reaction mechanism model formation unit 124 and the calculated reaction rate constants. Further, the number of times an elementary reaction occurred during the molecular dynamics calculation corresponds with the number of identical elementary reactions among the elementary reactions constructed by the reaction mechanism model formation unit 124. For example, at a temperature setting T1 (for example, 3000 K), if the elementary reaction A constructed by the reaction mechanism model formation unit 124 exists 10 times, then the number of times the elementary reaction A occurred during the molecular dynamics calculation at the temperature setting T1 becomes 10. The counting of the number of identical elementary reactions may be performed by the reaction mechanism model formation unit 124 (for example, the elementary reaction construction unit 122) or by the base model creation unit 126, but in either case, the counted numbers are used as the number of times each elementary reaction occurred during the molecular dynamics calculation at each temperature setting (hereafter, sometimes referred to as simply the number of occurrences of the elementary reaction).

The base model need not necessarily include the number of times each elementary reaction occurred during the molecular dynamics calculation. In such a case, the identical elementary reactions are not included in the base model as a single elementary reaction, but rather must all be included in the base model. For example, at the temperature setting T1 (for example, 3000 K), if the elementary reaction A constructed by the reaction mechanism model formation unit 124 exists 10 times, then ten occurrences of the elementary reaction A will exist in the elementary reaction list L1 of the base model.

Next, in step S52, the simplified model creation unit 128 extracts, from the base model created above, those elementary reactions for which the number of occurrences of the elementary reaction at each temperature setting is equal to or greater than a prescribed number (a) (with elementary reactions having fewer occurrences than the prescribed number (a) being deleted), and creates a provisional simplified model M1 including those elementary reactions for which the number of occurrences of the elementary reaction at each temperature setting is equal to or greater than a. For example, in the elementary reaction list L₁ at the temperature setting (T₁), in the case where the number of occurrences (a1) of an elementary reaction A is 10, the number of occurrences (a2) of an elementary reaction B is 4, the number of occurrences (a3) of an elementary reaction C is 2, and the prescribed number (a) is set to 3, the elementary reaction C is deleted, and an elementary reaction list L₁′ containing the elementary reactions A and B is created. The other lists L₂ to L_{N} are also treated in the same manner. The thus created provisional simplified model M1 is, for example, a model that is represented as elementary reaction lists L₁′ to L_{N}′ containing, for each temperature setting (T₁) to (T_{N}), each of the elementary reactions that occurred at least as many times as a prescribed number (for example, at least 3 times), and the reaction rate constant for each of those elementary reactions. In those cases where the base model does not include the number of occurrences of each elementary reaction, the number of identical reactions contained in the base model are counted, those elementary reactions for which the resulting count is equal to or greater than the prescribed number are extracted, and the provisional simplified model M1 is created.

Next, in step S54, the simplified model creation unit 128 creates a provisional simplified model M2 by extracting, from the provisional simplified model M1, those elementary reactions for which the number of temperature settings at which that same elementary reaction exists is equal to or greater than a prescribed number (b). For example, in the case where an elementary reaction A exists at 5 temperature settings (namely, exists in 5 elementary reaction lists), an elementary reaction B exists at 3 temperature settings (namely, exists in 3 elementary reaction lists), an elementary reaction C exists at 4 temperature settings (namely, exists in 4 elementary reaction lists), and the prescribed number (b) is set to 4, the elementary reaction B is deleted, and a provisional simplified model M2 containing the elementary reaction A and the elementary reaction C is created. In other words, the provisional simplified model M2 shown in FIG. 10 is a model including those elementary reactions that occurred at least as many times as the prescribed number of occurrences, and also exist for at least the prescribed number of temperature settings (namely, elementary reactions for which the reaction occurred at the prescribed number of temperature settings or more). The provisional simplified model M2 may, for example, be represented by an elementary reaction list for each of the temperature settings (T₁) to (T_{N}). In the present embodiment, the provisional simplified model M2 is transmitted to the model accuracy evaluation unit 130 as a simplified model.

In this manner, in the present embodiment, the number of elementary reactions within the base model is narrowed down on the basis of the number of times each elementary reaction occurred during the molecular dynamics calculation and the number of temperature settings at which the same elementary reaction exists, thereby reducing the number of elementary reactions from the base model to create a simplified model. However, the method used for narrowing down the number of elementary reactions within the base model is not limited to this particular method. For example, a model created by totaling the total number of occurrences of each elementary reaction in the base model, and then extracting those elementary reactions for which this total number of occurrences is equal to or greater than a prescribed number may also be used as a simplified model. Accordingly, any method may be used, provided that the simplified model creation unit 128 creates a simplified model in which the number of elementary reactions from the base model has been narrowed down based on the number of times each elementary reaction occurred during the molecular dynamics calculation. In terms of the accuracy and the like of the simplified model, the narrowing down of the elementary reactions from within the base model to create a simplified model is preferably performed by narrowing down the number of elementary reactions within the base model on the basis of the number of times an elementary reaction occurred during the molecular dynamics calculation at each temperature setting, and the number of temperature settings at which the same elementary reaction exists.

The simplified model created by the simplified model creation unit 128 preferably includes the reaction rate parameters (Arrhenius parameters) A, n and Ea for each elementary reaction. These reaction rate parameters can be determined by performing an Arrhenius equation fitting illustrated in FIG. 8 using the base model or the provisional simplified model M1 or the like. In order to calculate the reaction rate parameters, a separate reaction rate parameters calculation device may be provided, or a reaction rate parameters calculation function may be added to the simplified model creation unit 128 or the base model creation unit 126. Further, in those case where the reaction rate parameters are calculated in advance in the reaction mechanism model formation unit 124, these previously calculated reaction rate parameters may be included in the base model.

Next, in step S56, the accuracy of the simplified model is evaluated by the model accuracy evaluation unit 130. Evaluation of the accuracy is performed, for example, by comparing the reaction profile of the simplified model and the reaction profile of the base model, and determining whether or not the difference between the profiles falls within a specified tolerance. If the difference in the reaction profiles falls within the specified tolerance, then the simplified model is transmitted to the data storage unit 114 as a simplified reaction mechanism model, whereas if the difference in the reaction profiles exceeds the specified tolerance, then the prescribed values set in the manner described above (the number of times an elementary reaction occurred during the molecular dynamics calculation and the number of temperature settings at which the same elementary reaction exists) are reset, and a simplified model is once again created. In order to perform this resetting of the prescribed values, a prescribed values resetting unit or the like may be provided, or an operator or the like may directly enter the values from the input device 102. When the difference in the reaction profiles exceeds the specified tolerance, it can be assumed that an important elementary reaction that effects the reaction profile has been deleted in the creation of the simplified model, and therefore it is necessary that the reset prescribed values are set such that the number of elementary reactions increases compared with the number of elementary reactions of the previous simplified model.

There are no particular limitations on the reaction profile determined by the model accuracy evaluation unit 130, provided it can be determined by chemical kinetic calculations, and examples include mole fraction time history or ignition delay times or the like. Calculation of the reaction profile requires, for example, thermodynamic data such as the specific heat, entropy or enthalpy, and the reaction rate parameters (Arrhenius parameters) and the like. The thermodynamic data is preferably stored in advance in the model accuracy evaluation unit 130, but may also be input by an operator from the input device 102 at the time of the reaction profile calculations.

In those cases where the mole fraction time history is used as the reaction profile, the mole fraction time history for the base model may be obtained by converting the time history of the number of molecules, which has already been created as illustrated in FIG. 7, into a mole fraction time history, or alternatively, the time history may be determined by chemical kinetic calculations in a similar manner to the simplified model. The ignition delay time may be determined by chemical kinetic calculations using the base model and the simplified model respectively.

Even in those cases where the difference between the reaction profiles falls within the specified tolerance, further simplification of the elementary reactions may be performed based on the simplified model which falls within the specified tolerance. One such example is described below.

First, the simplified model described above is transmitted to the base model creation unit 126. At this point, the prescribed values that were set to narrow down the number of elementary reactions (namely, the number of times an elementary reaction occurred during the molecular dynamics calculation and the number of temperature settings at which the same elementary reaction exists) are reset. In the following description, the prescribed value for restricting the number of times an elementary reaction occurred during the molecular dynamics calculation is termed a, and the prescribed value for restricting the number of temperature settings at which the same elementary reaction exists is termed b.

The reset prescribed values are set so as to further reduce the number of elementary reactions (and the number of chemical species) in the newly created simplified model generated by the simplified model creation unit 128 compared with the number of elementary reactions (and the number of chemical species) in the simplified model transmitted to the base model creation unit 126. In principle, the larger the values of the prescribed values a and b become, the more the number of elementary reactions (and the number of chemical species) will be reduced, and therefore if the original setting for the prescribed value a was 3, and that for the prescribed value b was 4, then during the resetting process, the prescribed value a is set to a value greater than 3 (for example, 10), or the prescribed value b is set to a value greater than 4 (for example, 5), or both values may be reset. The simplified model creation unit 128 then deletes those elementary reactions that do not satisfy the reset prescribed values and creates a new simplified model. The prescribed values a and b are not limited to single values, and a plurality of values may be set for each value, thereby creating a plurality of new simplified models.

The accuracy of the newly created simplified model generated by the simplified model creation unit 128 is evaluated by the model accuracy evaluation unit 130. Evaluation of the accuracy is preferably performed by comparing the reaction profile of the initial base model created by the base model creation unit 126 and the reaction profile of the newly created simplified model, and determining whether or not the difference between the profiles falls within a preset tolerance, but the evaluation may also be performed by comparing the immediately previous simplified model and the newly created simplified model, and determining whether or not the difference between the profiles falls within a preset tolerance. In those cases where the specified tolerance is satisfied, the newly created simplified model is transmitted to the data storage unit 114 as a simplified reaction mechanism model.

Furthermore, in those cases where a plurality of new simplified models are created, all of those simplified models that satisfy the prescribed tolerance in the model accuracy evaluation unit 130 may be transmitted to the data storage unit 114, or the simplified model, among all the simplified models that satisfy the prescribed tolerance, that has the smallest number of elementary reactions (and number of chemical species) may be transmitted to the data storage unit 114 as a simplified reaction mechanism model.

The present embodiment enables the number of elementary reactions (and the number of chemical species) to be reduced while maintaining favorable model accuracy, and therefore executing a three-dimensional numerical fluid dynamics simulation using the reaction mechanism model becomes considerably easier. For example, by using the simplified reaction mechanism model, the time required for performing an engine combustion simulation can be shortened.

### EXAMPLES

The present invention is described below in further detail using a series of examples, but the present invention is in no way limited by the following examples.

### Example 1

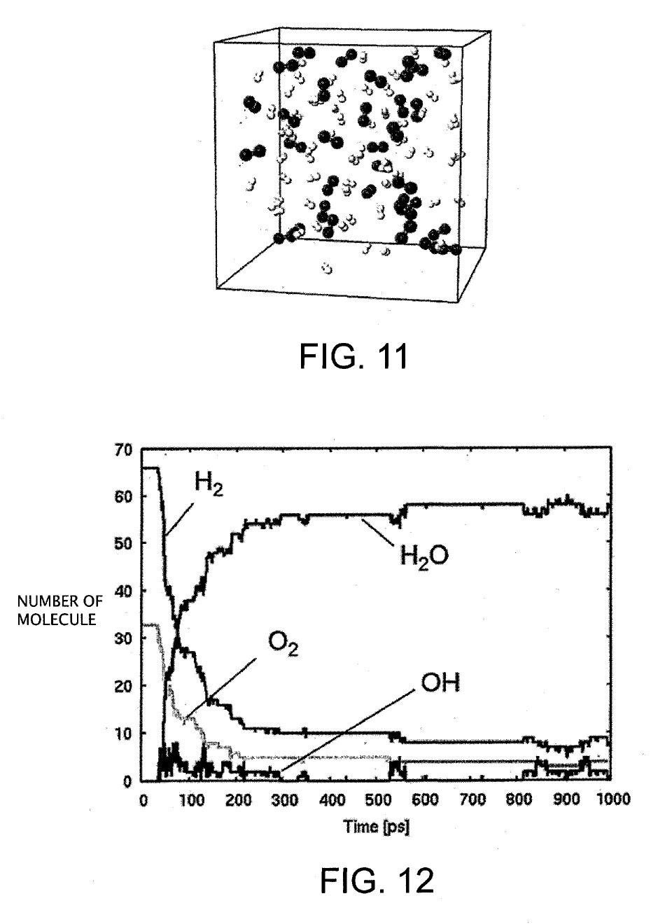

FIG. 11 is a diagram illustrating a state where hydrogen molecules and oxygen molecules are arranged in a simulation cell. In Example 1, 66 hydrogen molecules and 33 oxygen molecules were set in random positions inside a cubic simulation cell having a length along one side of 25 angstroms. Subsequently, a random initial speed was imparted to each atom to achieve a temperature at which the reaction rate constant is to be calculated. Based on the initial atom positions and the initial atom speeds, the positional information of each atom constituting each molecule was calculated sequentially in accordance with Newton's equation of motion represented by the above formula (1). The equation of motion was calculated by the difference method in relation to time. A variety of solution algorithms exist for the equation of motion, but in Example 1, the velocity Verlet method was used. The calculation time step was set to 0.1 femtosecond. Further, in order to maintain the temperature of the reaction system at a constant level, a Nose-Hoover thermostat was used. Furthermore, examples of the method used for calculating the force acting upon each atom include first principles methods, semi-empirical methods and molecular force field methods, but in Example 1, the reactive molecule force field method ReaxFF was used.

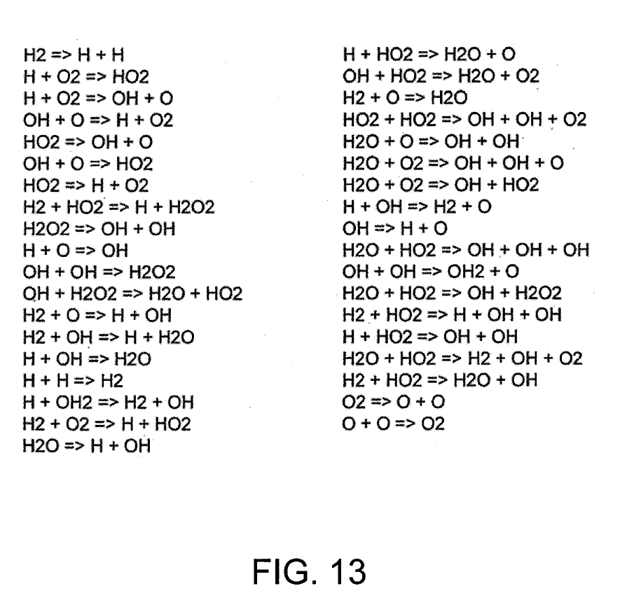

In Example 1, the bond orders obtained from the calculation processes of the reactive molecule force field method were used to determine whether bonds existed between atoms. The thresholds for the bond orders were set to 0.55 for H—H, 0.65 for O—O and 0.4 for O—H, and a bond was deemed to exist if the bond order was equal to or greater than the threshold. A value of “1” was assigned when a bond existed and a “0” was assigned in the case of no bond, and matrix information was created. Renewal of the matrix information was conducted each 1,000 time steps. This matrix information was converted to block diagonal form in the manner illustrated in FIG. 4, and the atom clusters were separated into molecules. In this manner, the molecules contained within the reaction system were identified every 1,000 time steps. The changes over time in the numbers of molecules identified in Example 1 is summarized in FIG. 12. In FIG. 12, only H₂, O₂, OH and H₂O are shown, but other molecules such as H₂O₂ and HO₂ were also identified in the analysis results. From the calculation results performed every 1,000 time steps, the molecules prior to the changes in the atomic bond information were listed as reacting molecules on the left side, the molecules after the changes were listed as product molecules on the right side, and reaction equations were constructed. At this time, in order to suppress the extraction of reaction equations composed of a mixture of a plurality of elementary reactions such as H+O₂+OH→OH+O+H+O₂, elementary reaction analysis such as that illustrated in FIGS. 5 and 6 was performed on the basis of the atomic relationships between the reacting molecules and the product molecules. FIG. 13 shows a list of the elementary reactions constructed in Example 1.

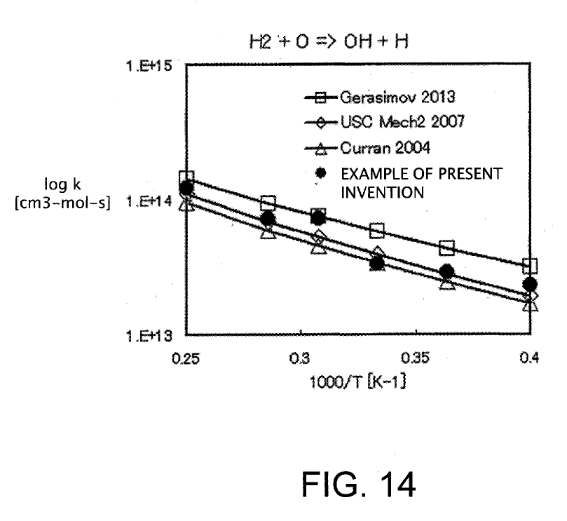

Next, the reaction rate constants of the obtained elementary reactions were calculated using the above formulas (7) and (8). In Example 1, the reaction rate constant for the elementary reaction H₂+O→OH+H was calculated at temperatures of 2500 K, 2750 K, 3000 K, 3250 K, 3500 K and 4000 K. The results are illustrated in FIG. 14. The reaction rate constants shown in FIG. 14 represent values obtained by performing 10 independent molecular dynamics calculations, and then calculating the statistical average. For reference purposes, values for reaction mechanisms constructed on the basis of experimental data and the like are also shown. As illustrated in FIG. 14, it can be stated that the results for the reaction rate constant obtained in Example 1 favorably reproduced the values obtained from the reaction mechanisms constructed on the basis of experimental data and the like.

### Example 2

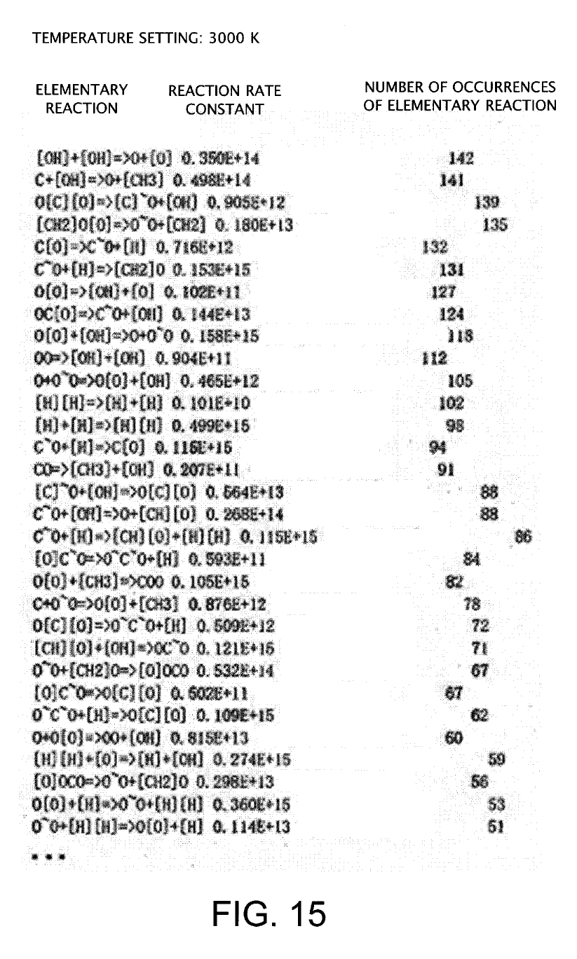

In Example 2, 50 methane molecules and 100 oxygen molecules were set in random positions inside a cubic simulation cell having a length along one side of 25 angstroms, molecular dynamics calculations (10 times) were performed in a similar manner to Example 1 at temperature settings of 3000 K, 3250 K, 3500 K, 3750 K and 4000 K, and the elementary reactions, the number of times each elementary reaction occurred during the molecular dynamics calculation, and the reaction rate constants were determined. FIG. 15 illustrates a portion of the base model including the elementary reactions at 3000 K, the reaction rate constants, and the number of times each elementary reaction occurred during the molecular dynamics calculation.

The prescribed value a was set to 3, and from the base model including the elementary reactions at each temperature setting, the number of occurrences of each elementary reaction and the reaction rate constants, those elementary reactions for which the number of occurrences of the elementary reaction was less than 3 were deleted to create a provisional simplified model into which only those elementary reactions having a number of occurrences of 3 or greater had been extracted. The reaction rate constant for an elementary reaction for which the number of occurrences is small tends to have a large statistical error, meaning the reliability of the value is low. By narrowing down the elementary reactions to those that occurred at least 3 times in the manner described above, those elementary reactions for which the error in the reaction rate constant is large are able to be deleted.

Next, using the provisional simplified model which had been narrowed down to those elementary reactions having a number of occurrences of 3 or greater, the Arrhenius equation fitting illustrated in FIG. 8 was performed, to determine the reaction rate parameters (A, n and Ea). Further, for each of the elementary reactions of the provisional simplified model, the number of temperature settings at which the same elementary reaction existed was calculated.

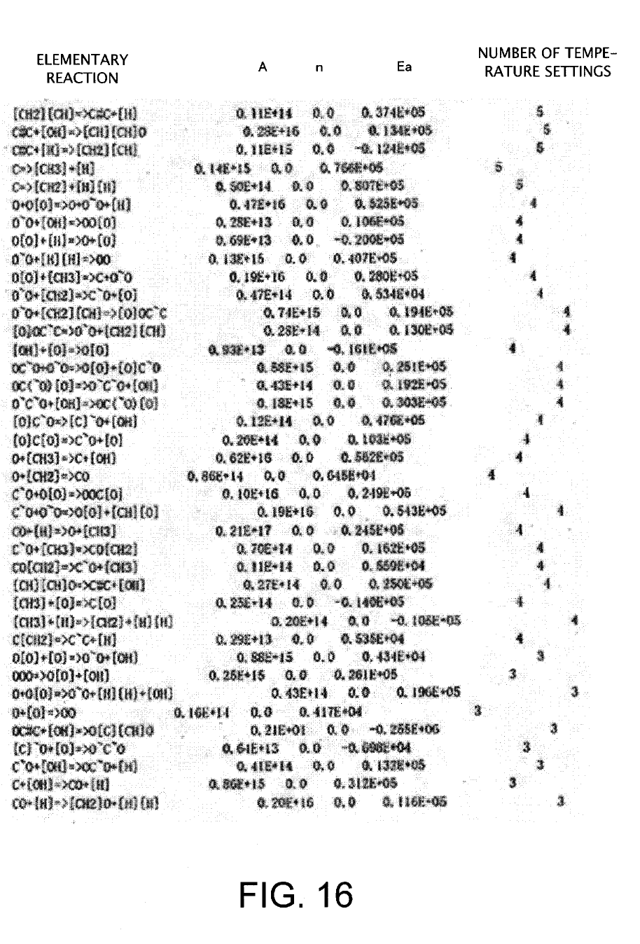

FIG. 16 illustrates a portion of a simplified model including elementary reactions, parameters (A, n, Ea), and the number of temperature settings at which each elementary reaction exists. The prescribed value b was set to 4, those elementary reactions for which the number of temperature settings at which the elementary reaction existed was less than 4 were deleted from the simplified model shown in FIG. 16, and a 3_4 simplified model was created containing those elementary reactions that existed at 4 or more temperature settings. Hereafter a simplified model generated by narrowing down the number of elementary reactions by setting the number of occurrences of the elementary reaction to a or greater, and setting the number of temperature settings at which the elementary reaction exists to b or greater, is termed an a_b simplified model.

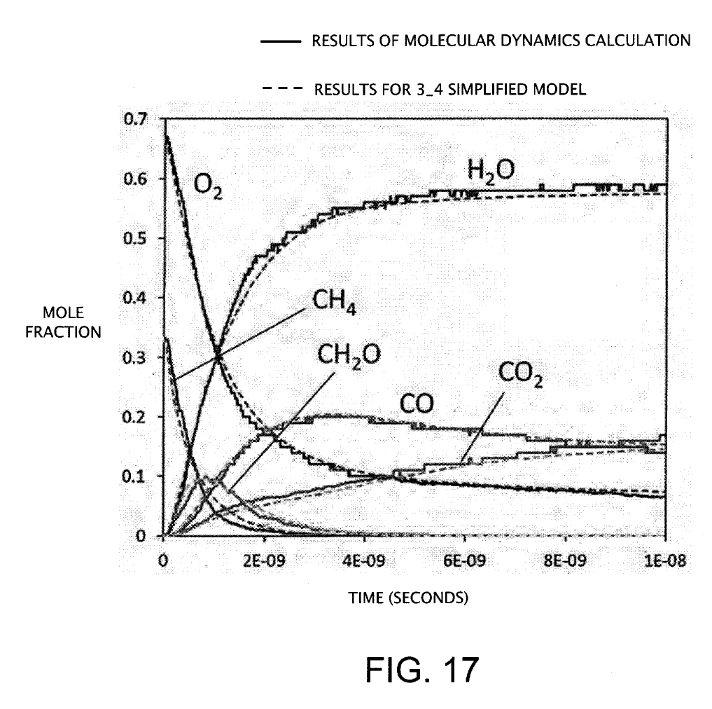

FIG. 17 illustrates the changes over time in mole fractions at 3000 K using the 3_4 simplified model, and the changes over time in the mole fractions obtained by molecular dynamics calculations. The targeted chemical species were methane, oxygen, formaldehyde, water, carbon monoxide and carbon dioxide. The changes over time in the mole fractions using the 3_4 simplified model were determined by chemical kinetics calculations. Further, the changes over time in the mole fractions obtained by molecular dynamics calculations were obtained by determining the change over time in the number of each molecule in the molecular dynamics calculations conducted in Example 2, and then converting those results to mole fractions.

As illustrated in FIG. 17, the changes over time in mole fractions obtained using the 3_4 simplified model favorably reproduced the changes over time in the mole fractions obtained from the molecular dynamics calculations. Specifically, across the entire time period, the mole fractions obtained using the 3_4 simplified model were within 5.7% of the corresponding mole fractions obtained by the molecular dynamics calculations, confirming that a simplified model of good accuracy had been obtained.

The 3_4 simplified model contained 253 elementary reactions and 64 chemical species. On the other hand, the base model contained 370 elementary reactions and 92 chemical species. In other words, it can be stated that compared with the base model, the 3_4 simplified model is a simplified reaction model in which the number of elementary reactions and the number of chemical species have been reduced while maintaining the model accuracy.

Next, using the 3_4 simplified model as a base, a further simplification of the number of elementary reactions was performed.

First, the prescribed value for the number of occurrences of an elementary reaction was set within a range from 3 to 40, and the number of temperature settings at which the elementary reaction exists was set within a range from 2 to 5, and by narrowing the number of elementary reactions in the same manner as described above, simplified models (a 3_2 simplified model through to a 40_5 simplified model) were created.

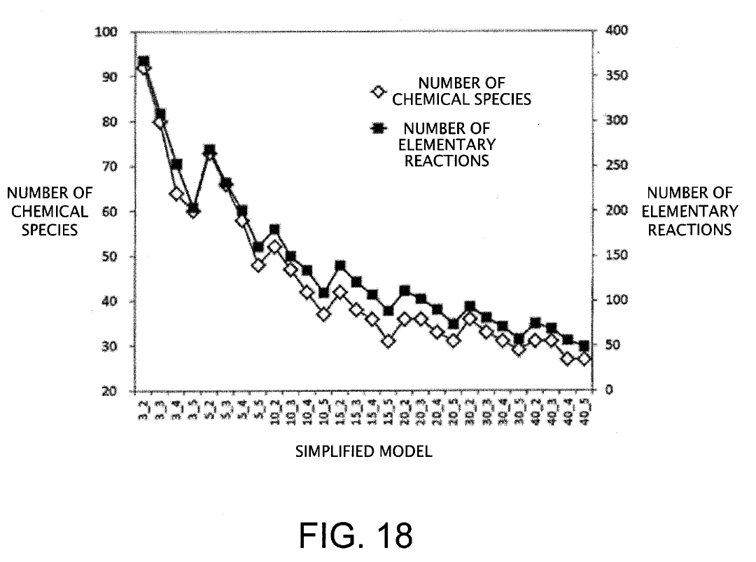

The number of elementary reactions and the number of chemical species within each simplified model are summarized in FIG. 18. The number of elementary reactions and the number of chemical species at the leftmost side of the broken lines in FIG. 18 represent the number of elementary reactions and the number of chemical species for the initially set base model, whereas the number of elementary reactions and numbers of chemical species from the second point from the leftmost side onward correspond with the simplified models (the 3_2 simplified model through to the 40_5 simplified model).

Next, for each of the simplified models in which the number of elementary reactions had been narrowed down, the ignition delay time under constant volume adiabatic conditions (at temperatures of 1000 K, 1500 K, 2000 K, 2500 K and 3000 K) was determined by chemical kinetics calculations. The point where the temperature had increased 1000 K from each initial temperature was deemed the ignition point, and the ignition delay time was calculated.

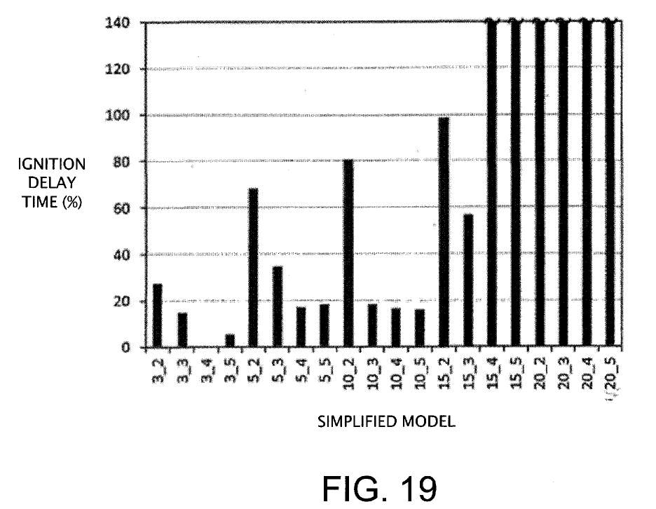

FIG. 19 illustrates the results of calculating the ignition delay time for the 3_2 simplified model through to the 20_5 simplified model. The ignition delay times indicated in FIG. 19 are referenced against the ignition delay time of the base 3_4 simplified model, and represent the percentage change (%) in the ignition delay time for each of the other simplified models relative to the ignition delay time for the reference. As is evident from FIG. 18, the 3_2 simplified model, the 3_3 simplified model and the 3_5 simplified model each contain a larger number of elementary reactions and a larger number of chemical species than the 3_4 simplified model, and therefore under normal circumstances, evaluation of the ignition delay times for these models need not be performed.

When the tolerance for the percentage change in the ignition delay time for each simplified model besides the 3_4 simplified model relative to the ignition delay time of the 3_4 simplified model was set to 20% or less, and the accuracy of the simplified models was evaluated, the 5_4 simplified model, the 5_5 simplified model, the 10_3 simplified model, the 10_4 simplified model and the 10_5 simplified model were within the specified tolerance. The 3_3 simplified model and the 3_5 simplified model were also within the specified tolerance, but as mentioned above, the number of elementary reactions and the number of chemical species are both larger than the 3_4 simplified model, and therefore they were not evaluated.

The 5_4 simplified model, the 5_5 simplified model, the 10_3 simplified model, the 10_4 simplified model and the 10_5 simplified model may all be identified as simplified reaction mechanism models, but among these, it is preferable that the 10_5 simplified model, which has the smallest number of elementary reactions and the smallest number of chemical species, is identified as the reaction model. In Example 2, comparison was made with the ignition delay time of the 3_4 simplified model, but comparison may of course also be made against the ignition delay time of the initially set base model.

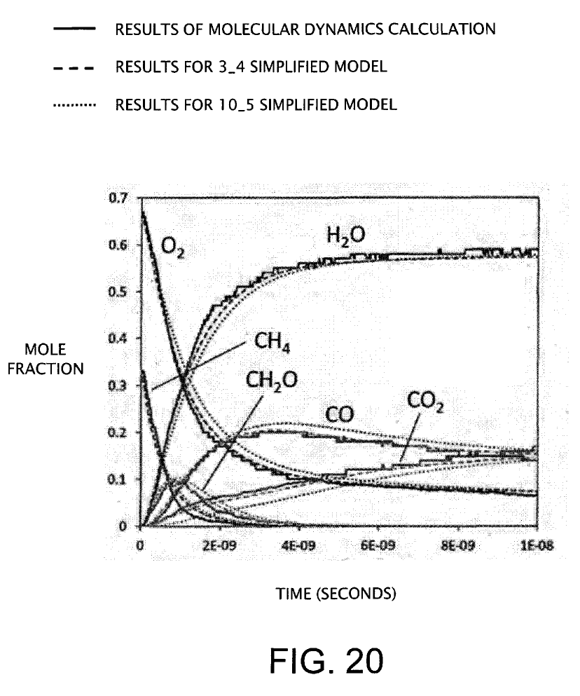

FIG. 20 illustrates the changes over time in mole fractions at 3000 K using the 10_5 simplified model. Further, for the purposes of comparison, the changes over time in the mole fractions using the 3_4 simplified model and the changes over time in the mole fractions obtained by molecular dynamics calculations are also shown. The targeted chemical species were methane, oxygen, formaldehyde, water, carbon monoxide and carbon dioxide.

As illustrated in FIG. 20, the changes over time in the mole fractions obtained using the 10_5 simplified model favorably reproduced the changes over time in the mole fractions obtained from the molecular dynamics calculations. Specifically, across the entire time period, the mole fractions obtained using the 10_5 simplified model were within 14.8% of the corresponding mole fractions obtained by the molecular dynamics calculations.

The 10_5 simplified model contained 109 elementary reactions and 37 chemical species. In other words, it can be stated that compared with the base model containing 370 elementary reactions and 92 chemical species and the 3_4 simplified model containing 253 elementary reactions and 64 chemical species, the 10_5 simplified model is a simplified reaction model in which the number of elementary reactions and the number of chemical species have been dramatically reduced while maintaining the model accuracy.

### Reference Example

Using the 3_4 simplified model as a base, three conventionally known simplification methods, namely the DRG (Directed Relation Graph) method, the DRGEP (DRG with Error Propagation) method, and the DRGEPSA (DRGEP and Sensitivity Analysis) method, were performed to simplify the model. In these three simplification methods, in a similar manner to that described in Example 2, the model simplification was performed so that the ignition delay time under constant volume adiabatic conditions for the obtained simplified model was within 20% of the ignition delay time of the 3_4 simplified model. The above three simplification methods were also performed using the 10_5 simplified model as a base.

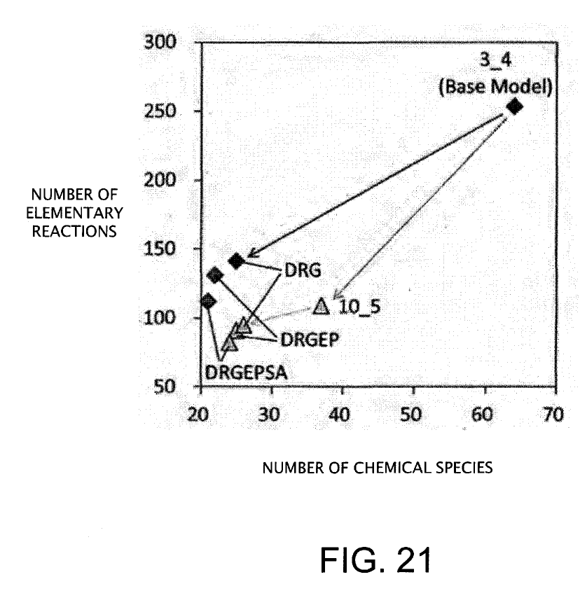

FIG. 21 illustrates the results for the number of elementary reactions and the number of chemical species in the simplified models obtained using the three conventionally known simplification methods. As illustrated in FIG. 21, using the 3_4 simplified model as a base, the DRG method yielded 141 elementary reactions and 25 chemical species, the DRGEP method yielded 131 elementary reactions and 22 chemical species, and the DRGEPSA method yielded 112 elementary reactions and 21 chemical species. In Example 2, the 10_5 simplified model obtained using the 3_4 simplified model as a base contained 109 elementary reactions and 37 chemical species, meaning that it can be stated that, compared with the conventional simplification methods, Example 2 was able to provide greater simplification in terms of the number of elementary reactions.

Furthermore, using the 10_5 simplified model as a base, the DRG method yielded 95 elementary reactions and 26 chemical species, the DRGEP method yielded 91 elementary reactions and 25 chemical species, and the DRGEPSA method yielded 82 elementary reactions and 24 chemical species. Based on these results, it is evident that by combining the simplification of Example 2 with conventional simplification methods, reaction models having even fewer elementary reactions can be created.

### REFERENCE SIGNS LIST

100, 101: Reaction mechanism generation device
102: Input device
104: Output device
106: Reaction conditions setting unit
108: Initial conditions setting unit
110: Molecular dynamics calculation unit
112: Reaction rate constant calculation unit
114: Data storage unit
116: Display control unit
120: Molecule identification unit
122: Elementary reaction construction unit
124: Reaction mechanism model formation unit
126: Base model creation unit
128: Simplified model creation unit
130: Model accuracy evaluation unit

1. A reaction mechanism generation method comprising:
a step of performing a molecular dynamics calculation at each time step for atoms that constitute each molecule in a reaction system,
a step, performed when a chemical reaction has occurred in the reaction system before and after the time step, of identifying a reacting molecule and a product molecule that contributed to the chemical reaction,
a step of constructing, based on atomic relationships between the reacting molecule and the product molecule, an elementary reaction structured from the reacting molecule and the product molecule having the relationship, and
a step of calculating a reaction rate constant for the constructed elementary reaction.

2. The reaction mechanism generation method according to claim 1, wherein
in the step of identifying a reacting molecule and a product molecule, the reacting molecule and the product molecule that contributed to the chemical reaction are identified from positional information for atoms obtained from molecular dynamics calculations performed before and after the time step.

3. The reaction mechanism generation method according to claim 1, wherein
in the step of calculating a reaction rate constant for the elementary reaction, a time history of a number of molecules of the same molecular species as the reacting molecule is calculated, and the reaction rate constant for the elementary reaction is then calculated based on the time history of the number of molecules of the same molecular species as the reacting molecule.

4. The reaction mechanism generation method according to claim 1, further comprising:
a step of creating a base model comprising a plurality of elementary reactions constructed in the step of constructing an elementary reaction, and
a step of creating a simplified model having fewer elementary reactions than the base model, by narrowing down the plurality of elementary reactions of the base model based on a number of times each elementary reaction occurred during the molecular dynamics calculation.

5. The reaction mechanism generation method according to claim 4, further comprising a step of evaluating accuracy of the simplified model.

6. The reaction mechanism generation method according to claim 1, further comprising:
a step of creating a base model comprising a plurality of elementary reactions constructed in the step of constructing an elementary reaction, and
a step of creating a simplified model having fewer elementary reactions than the base model, by narrowing down the plurality of elementary reactions of the base model based on a number of times each elementary reaction occurred during the molecular dynamics calculation and a number of temperature settings, among a plurality of temperature settings set in the molecular dynamics calculation, at which the same elementary reaction exists.

7. The reaction mechanism generation method according to claim 6, further comprising a step of evaluating accuracy of the simplified model.

8. A reaction mechanism generation device, comprising:
a molecular dynamics calculation unit that performs a molecular dynamics calculation at each time step for atoms that constitute each molecule in a reaction system,
a molecule identification unit which, when a chemical reaction has occurred in the reaction system before and after the time spte, identifies a reacting molecule and a product molecule that contributed to the chemical reaction,
an elementary reaction construction unit which, based on atomic relationships between the reacting molecule and the product molecule, constructs an elementary reaction structured from the reacting molecule and the product molecule having the relationship, and
a reaction rate calculation unit that calculates a reaction rate constant for the constructed elementary reaction.

9. The reaction mechanism generation device according to claim 8, wherein
the molecule identification unit identifies the reacting molecule and the product molecule that contributed to the chemical reaction from positional information for atoms obtained from molecular dynamics calculations performed before and after the time step.

10. The reaction mechanism generation device according to claim 8, wherein
the reaction rate calculation unit calculates a time history of a number of molecules of the same molecular species as the reacting molecule, and calculates the reaction rate constant for the elementary reaction based on the time history of the number of molecules of the same molecular species as the reacting molecule.

11. The reaction mechanism generation device according to claim 8, further comprising:
a base model creation unit that creates a base model comprising a plurality of elementary reactions constructed in the elementary reaction construction unit, and
a simplified model creation unit that creates a simplified model having fewer elementary reactions than the base model, by narrowing down the plurality of elementary reactions of the base model based on a number of times each elementary reaction occurred during the molecular dynamics calculation.

12. The reaction mechanism generation device according to claim 11, further comprising a model accuracy evaluation unit that evaluates accuracy of the simplified model.

13. The reaction mechanism generation device according to claim 8, further comprising:
a base model creation unit that creates a base model containing a plurality of elementary reactions constructed in the elementary reaction construction unit, and
a simplified model creation unit that creates a simplified model having fewer elementary reactions than the base model, by narrowing down the plurality of elementary reactions of the base model based on a number of times each elementary reaction occurred during the molecular dynamics calculation and a number of temperature settings, among a plurality of temperature settings set in the molecular dynamics calculation, at which the same elementary reaction exists.

14. The reaction mechanism generation device according to claim 13, further comprising a model accuracy evaluation unit that evaluates accuracy of the simplified model.
